(19) United States
(12) Patent Application Publication
(10) Pub. No.: US 2012/0053845 A1
(43) Pub. Date: Mar. 1, 2012

(54) Method and system for analysis and error correction of biological sequences and inference of relationship for multiple samples

(76) Inventors: Jeremy Bruestle, Seattle, WA (US); Becky Drees, Seattle, WA (US); Tim Hunkapillar, Seattle, WA (US)

(21) Appl. No.: 13/095,707

(22) Filed: Apr. 27, 2011

Related U.S. Application Data
(60) Provisional application No. 61/328,591, filed on Apr. 27, 2010.

(51) Int. Cl. G06F 19/18

(52) U.S. Cl. 702/20

(57) ABSTRACT

In one method embodiment low-coverage genome sequence data for each individual in a group of related individuals is obtained, the alignment of read sequences is determined relative to a reference sequence and to each other in a padded multiple alignment, the relative likelihoods of the observed base calls and quality scores obtained from the set of sequence reads for each individual for each position are determined for possible individual genotypes at that position, the most likely shared genotype between individuals for each position is determined to define a multi-individual consensus for each position, and individual genotypes and confidence levels are imputed to produce an error-corrected genome sequence for each individual.

### CROSS-REFERENCE TO RELATED APPLICATION

This application claims the benefit of Provisional Application No. 61/328,591, filed Apr. 27, 2010.

### TECHNICAL FIELD

This application is directed to the fields of molecular biology, genetics, and medicine and, in particular, to methods and systems for analysis, error correction, and imputation of subunit sequences for biological polymers, and inference of relationships from biological sequence data.

### BACKGROUND

High-throughput DNA sequencing technologies, increased computing power, and access to reference sequence data from the Human Genome Project and other genome projects have fueled an ongoing explosive increase in the use of DNA sequence data, including whole genome sequence data from single individuals, in biological and medical research. Several high-throughput sequencing platforms are in common use. Technologies differ in the details, but share a common strategy: massively parallel sequencing of a dense array of microscopic DNA features in repeating cycles. Automated array-based sequencing on a high-throughput sequencing instrument allows hundreds of millions of sequencing reactions to be read in parallel, causing the cost of DNA sequencing to drop dramatically.

Growing deployment of these technologies has driven many recent advances in molecular biology and medical genetics. Increasing throughput and decreasing costs have made whole-genome sequencing of individual patients possible, revolutionizing the way medical geneticists identify and screen for disease-causing mutations. Personal genome sequence data, along with relevant environmental and medical information, will characterize the integrated medical records of the future.

Genetic linkage mapping studies in family pedigrees once used a few thousand genetic markers to survey the entire human genome. While limited, this approach successfully identified causative mutations for some single-gene inherited disorders and mapped a few genes that influence complex traits. The development of DNA microarray technology has made it possible to rapidly genotype up to a million positions from a large number of case and control subjects. Hundreds, of genome-wide association studies have been performed for human diseases and traits. Medical geneticists hope to uncover a large fraction of total genetic variability associated with common diseases. However, study results have consistently found that the common gene variants detected appear to be responsible for only a small amount of the variation that exists in the human population.

Even with a million markers, microarray genotyping is limited to the detection of alleles that are relatively common (>5% incidence in the population). Common variants account for a sizable fraction of the heritability of some conditions—notably, exfoliation glaucoma, macular degeneration, and Alzheimer's disease. But the effect of common variation on the majority of common disease risks—for example, diabetes, cancer, or autoimmune disease—is far less than expected. Instead, much of the heritability of common diseases appears to be due to rare (<1% incidence in the population) and generally deleterious variants that have a strong impact on the risk of disease in individual patients. For example, a study in which the tumor suppressor genes BRCA1, BRCA2, and multiple other genes were sequenced for multiple individuals from families with an inherited predisposition for high risk of breast and ovarian cancer revealed that, while cancer-associated inherited mutations in these genes are collectively quite common, any given individual mutation is quite rare and often private to a single family pedigree. A family-based sequencing strategy, in which targeted gene regions or whole genomes of individuals in selected families or population subgroups are sequenced, is emerging as a particularly effective approach for discovery of new causative mutations of inherited disease. Whole genome sequencing of affected and unaffected individuals in a family group maximizes ability to detect and assess high-impact variants.

Personal genetic information is not yet widely used for medical decision-making, but as genetics becomes more heavily integrated into the medical field, knowledge of an individual's genome is likely to be an important part of personalized health care. Despite its increasing affordability, whole genome sequencing is a high cost diagnostic procedure, a factor that inhibits widespread medical use. Whole-genome sequencing is moving rapidly into clinical practice in the field of cancer genetics, where stakes are high and the costs less significant compared to other costs of cancer treatment. Comparison of genome sequence and transcription profiles from normal tissue to that of cancerous tissue from the same patient can detect cancer-specific mutations associated with differences in disease state, prognosis, metastasis, and drug response profile. This information can be useful for determining the best course of treatment.

The recent success of family-based sequencing approaches in identifying causal mutations for inherited disorders is leading to its adoption as an exploratory diagnostic strategy for cases of uncharacterized genetic disorders. Personal genome sequence data, along with relevant environmental and medical information, will characterize the integrated medical records of the future.

### SUMMARY

The current application is directed to methods and systems for analysis, error correction, and imputation of subunit sequences for biological polymers, including nucleic acids, and to methods and systems for inference of biological or functional relationship between biological samples from such biological sequence data. In one method embodiment low-coverage genome sequence data for each individual in a group of related individuals is obtained, the alignment of the read sequences is determined relative to a reference sequence and to each other in a padded multiple alignment, the relative likelihoods of the observed base calls and quality scores obtained from the set of sequence reads for each individual for each position are determined for individual genotypes at that position, the most likely shared genotype between individuals for each position is determined to define a multi-individual consensus for each position, and individual genotypes and confidence levels are imputed to produce an error-corrected genome sequence for each individual. Other methods and systems embodiments may be applied for analysis, comparison and error correction of any type of data describing the subunit sequence of a biological polymer, sequence imputation for any set of biologically or functionally related samples from such data, and inference of biological relationship or molecular function for any set of individuals or biological samples from such data.

### BRIEF DESCRIPTION OF THE DRAWINGS

FIG. 1 provides an illustration of an example of our method for analysis of sequence data from multiple biological samples applied to family-based genome sequencing.

FIG. 2 provides an illustration of an example of an embodiment for inference of a degree of biological relationship applied to genomic DNA sequences obtained from multiple individuals with unknown degrees of relationship.

FIG. 3 provides an outline of a process for obtaining nucleic-acid sequence data for a biological sample.

FIG. 4 provides an illustration of a pedigree diagram for a family trio used for the example method embodiment for analysis of sequence data from multiple biological samples applied to family-based genome sequencing, consisting of two parents and a single offspring.

FIG. 5 provides an illustration of padded multiple alignment.

### DETAILED DESCRIPTION

This application is directed to methods and systems that produce complete and accurate whole genome consensus and variant detection for multiple individuals in a family or other related group from low-coverage genome sequence data, increasing efficiency and decreasing costs to enable more widespread medical applications.

The instructions for making the cells of any organism are encoded in deoxyribonucleic acid (DNA). The DNA molecule is a double helix held together by the interacting pairs of its internal bases. These are the four nucleotides adenine, thymine, cytosine and guanine (A, T, C and G). The two strands are paired in a restricted way: G with C, A with T. The complete sequence of these four letters that make up an individual organism's DNA is referred to as that individual's genome. In higher organisms, the long molecules of DNA in cells are organized into pieces called chromosomes. Individuals in sexually reproducing species have two copies of each chromosome, one inherited from each parent. Information in the genome is regulated in a complex way, interacting with environmental influences to produce the biological readout of a unique individual. Information about an individual's DNA sequence is referred to as genotypic information. Regions of a particular individual's genome can also be referred to as “DNA sequences.”

Although the genomes of individuals of the same species are very similar overall, they contain sequence variants at millions of places. For example, the average rate of heterozygosity in the human genome, the probability that the two randomly selected people will have different sequences at any given position of their genome, is approximately 1 in 1000 bases. While the rate seems small, it predicts that comparison of two human genomes of 6 billion bases each may show as many as 6 million sequence variants between them. Published individual human genome sequences have between 2 and 4 million sequence variants compared to the human reference assembly.

Closely related individuals, such as members of a family group, share large sections of identical DNA sequence, referred to as shared haplotypes or regions of identity-by-descent. The amount of shared haplotype between two individuals is dependent on the degree of genetic relatedness between them. For example, a child inherits half of his genome from each parent, so in a parent-child pair, approximately 50% of their genome sequences will be shared identity-by-descent regions. Accordingly, a grandparent-grandchild pair share approximately 25% of their genome sequence, and full siblings share approximately 50%. Close relatives share long identity-by-descent regions in their genomes, so that data on a small set of genetic markers for individuals in a known pedigree can be used to predict genetic variants not observed directly based on shared haplotype. As genetic relationships become more distant-from families, to population groups, to larger populations—the likelihood that two individuals will have the same genotype at a particular position decreases in proportion to the decrease in the degree of relatedness between them. With the recent advent of exome and genome sequencing for medical diagnostics, variant calls from sequence data analysis can serve as a dense set of markers that can define identical-by-descent chromosomal regions at a high resolution. The precise definition of inherited chromosome regions reduces the search space for candidate mutations to a fraction of the whole genome and the effects of very rare alleles can be most easily detected in small pedigrees, so that sequencing genomes of family groups is an ideal strategy for identification of many disease-causing mutations.

The ability to detect a given variant in a group of individuals via high-throughput sequencing technology is dominated by two factors: (1) whether the variant allele is present among the individuals chosen for sequencing; and (2) the number of high quality and well mapped reads that overlap the variant site in individuals who carry it. Accuracy of sequencing results correlates with higher coverage data. The chemistries used in high-throughput sequencing methods have an inherent bias, so that some DNA sequences are more likely to be read than others, and an inherent error rate. Depending on the platform used and other factors, read errors occur anywhere in the range of one per 100-2000 bases. Most errors are misidentified bases from low-quality basecalls. The error rate is usually accommodated by oversampling, that is, resequencing every base many times to achieve a high-quality consensus. The number of times that a fragment is read is referred to as its coverage. The average coverage for a sequence is the average number of reads taken for any given DNA fragment during the sequencing process. If a sample is sequenced to a high average rate of coverage, any given region is represented by multiple independent reads, thus reducing the impact of an erroneous read in the analysis. Additional error correction on high-coverage sequence data can be done by generating short k-mer sequences from a sequence read dataset, calculating the frequency of each k-mer's occurrence, and discarding those that occur at low frequency as likely sequencing errors.

Recently published individual human genome sequences were sequenced to an average coverage of anywhere from 20×, indicating each fragment was read an average of 20 times, to 80×. At this coverage, even poorly sequenced regions are likely to be read several times. At 30× and above coverage, high-throughput sequencing technologies have good variant calling accuracy and can reliably detect sequence variants and heterozygous alleles. Published whole human genome sequences cover 98% or more of the reference human genome assembly with a high level of accuracy, demonstrated by 95% or greater agreement with separately assayed SNP genotypes for the same individual.

### Analysis and Error Correction of Biological Sequences for Multiple Related Samples

In one embodiment, methods for nucleic-acid sequence analysis are provided to reduce costs for genome sequencing for multiple samples, which helps advance genetic research, enables improved diagnostics for medical genetics, and potentially aids effective drug development. Application of such methods to family groups can give consumers access to their family genetic information, enabling them to make better decisions about their health. The described methods allow genome-sequence analysis of multiple biologically-related samples to be done at a low average depth of coverage per individual sample, significantly reducing the cost and analysis time for the group as a whole. Instead of using increased sampling, such methods use information about the degree of relatedness within a group of related samples to correct for error rate, to boost coverage, and to accurately detect sequence variants. In effect, the methods use the degree of relatedness to boost the sequence coverage of shared regions and impute bases for missing or low-confidence subsequences for each individual sample. This method enables and allows for accurate sequences to be obtained for a group of related individuals from data with a low average depth of sequence coverage. The ability to use low-coverage data is a significant advantage in time and cost per sequence. The method's applicability to data from related individuals makes it particularly useful for genetic counseling, pedigree-based genetic research, and direct-to-consumer genetic information services.

In another embodiment, a method for quantitatively inferring the degree of genetic relationship between individual biological samples from sequence data is provided that enables other applications based on inference of the degree of genetic relationship, including placement of individuals in extended pedigrees. Among the most useful of these for medical and diagnostic purposes are comparisons of sequences from different biological samples from the same individual organism, such as comparison of samples from cancerous or diseased tissue to samples from normal tissue, comparison of samples collected from different tissues or at different times, or comparison of RNA and DNA sequences.

Method embodiments include, but are not limited to:
(1) analysis and comparison of sequence data from multiple biological samples that produces a set of accurate individual nucleic-acid sequences for a group of samples based on the biological relationships between them, and
(2) inferring the degree of biological relationship between individual biological samples.
These methods are particularly useful for application to whole genome sequencing, but may be applied to other types of sequences. Examples of sample groups that these methods can be applied to include: samples from groups made of closely related individuals, such as family groups, samples from different individuals from a particular genetic population, or different samples collected from the same individual, such as different tissue types.

Having described the invention with reference to the embodiments and illustrative examples, those skilled in the art may appreciate modifications to the invention as described and illustrated herein that do not depart from the spirit and scope of the invention as disclosed in the specification. The examples below are set forth to aid in understanding the invention but are not intended to, and should not be construed to limit its scope in any way. The examples do not include detailed descriptions of conventional methods. Such methods are well known to those of ordinary skill in the art and are described in numerous publications.

### Example 1

### Analysis of Sequence Data from Multiple Biological Samples

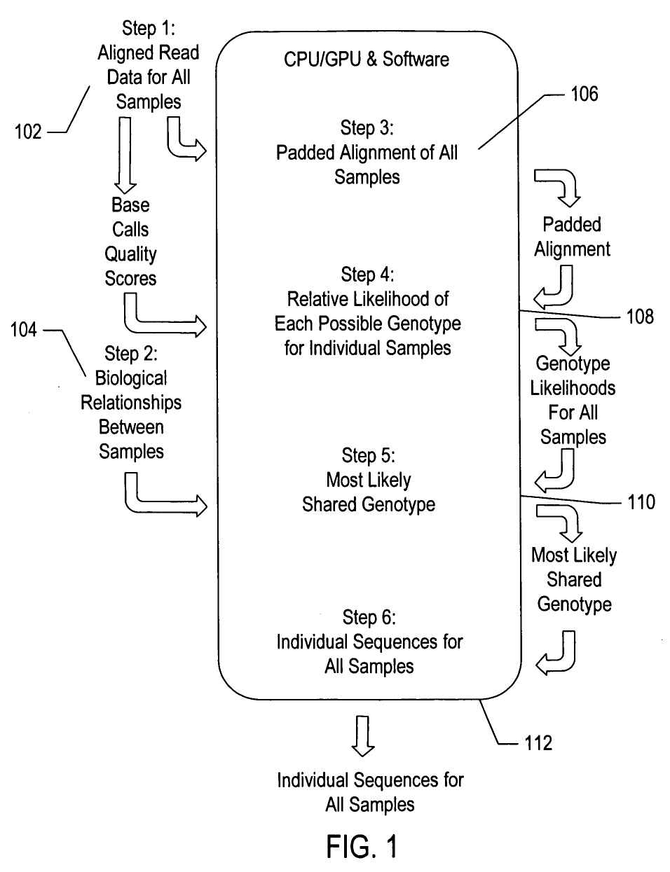

An example of the use of a method embodiment for family-based sequencing is outlined below and illustrated in FIG. 1. In this example, samples are genomic DNA samples from a set of related individuals. However, the invention can be applied to other types of samples and sample groups.

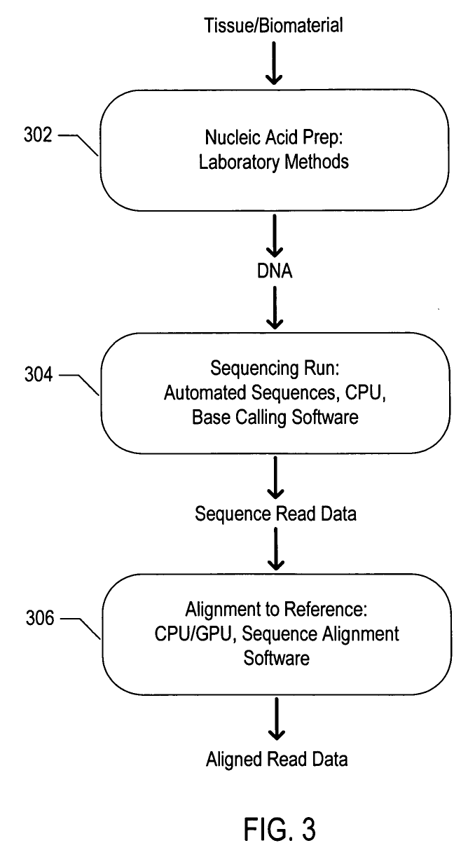

Step 1 (102 in FIG. 1): As one input, the method receives nucleic acid sequence data for multiple individual samples. FIG. 3 shows a simple outline of the process of obtaining sequence data for a biological sample, including nucleic-acid extraction 302, nucleic-acid sequencing 304, and sequence alignment 306. Data for each position of a sequence read consists of a basecall, identifying the nucleotide as A,C, G, or T, and a quality score Q assigning a confidence level to the call that is logarithmically related to its error probability P:

Q=[−10(log₁₀P)]

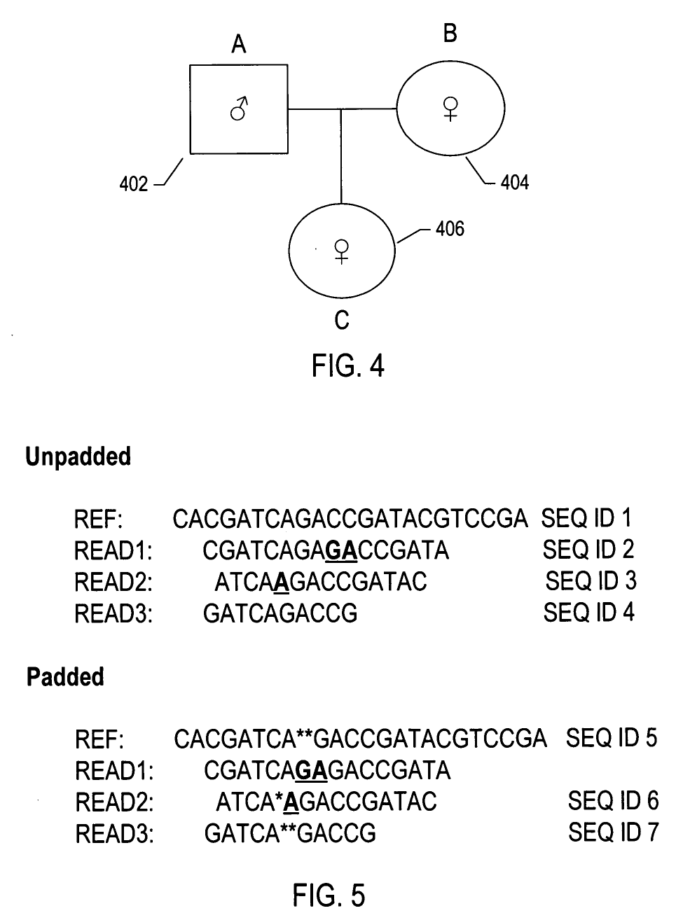

Individual samples may be sequenced separately, or multiple individual samples can be barcoded with unique oligonucleotide tags, combined, and sequenced as a pool. Different samples from a group of related individuals may be sequenced to different average levels of coverage in order to optimize overall coverage of the group depending on the imputation algorithm and the knowledge of the biological relationship between individuals.
Step 2 (104 in FIG. 1): As a second input, the method receives an indication of the biological relationships between the individual samples. In the case of a family-based sequencing, degree of relatedness is derived from the pedigree structure of the family, as shown in FIG. 4. As the offspring of A 402 and B 404, C 406 inherits half of her genome from each parent. It is expected that approximately 50% of C's genome sequence is shared haplotypes with parent A's genome and the remaining 50% will be shared haplotypes with B's. Unless A and B are themselves close relatives, they will not share large regions of identity by descent.
Step 3 (106 in FIG. 1): The alignment of read sequences is determined relative to the reference sequence and to each other. A padded multiple alignment of the read sequences is obtained by inserting some number of spaces ≧0 in each sequence position to yield sequence strings of equal length. An example of padded alignment is shown in FIG. 5.

Padded multiple alignment of reads to a reference and each other is done as follows. For each read, an alignment relative to the reference sequence is performed. The reference sequence may be a consensus reference assembly for the human genome or the genome of another species, or the genome assembly of a population subgroup or single individual. Alignment to the reference can be done using existing alignment software, such as Bowtie, BWA, or others. An array is constructed containing one element for each position xᵢ in a reference sequence of length R. Array values at positions x₀, x₁, x₂, . . . x_{A} are initialized to 1 so that the value of the array A is equal to the length R of the reference. The alignment of each read is reviewed, and for base inserts relative to the reference sequence at position xᵢ, the entry in the array is taken at position xᵢ₋₁ immediately preceding the insert, and the value of the array A is adjusted to the maximum of its previous value plus 1 plus the size of the insert n:

A=R+n+1

In cases of base deletions relative to the reference inserts, a gap is inserted into the read alignment of a read at the position following the last reference match and the value of the array is not affected. After the array has been adjusted for read alignments, the prefix sum of the adjusted array is computed:

y₁=x₁

y₂=x₁+x₂

y₁=x₁+x₂ . . . +x_{A}

This results in an array of multiple sequence alignments in which every position in the reference sequence is represented in the final padded alignment. For each position, there exists a set of reads from each individual that overlaps that location. For each read mapped to that position, there is either a basecall and associated quality score or a deletion relative to the padded alignment. All matches, simple mismatches, insertions, and deletions from each read can be properly mapped.

Step 4 (108 in FIG. 1): For each individual, the relative likelihoods of the observed base calls and quality scores obtained from the set of sequence reads sampling that individual's genome for each position in the alignment are determined for possible individual genotypes at that position. This is computed as follows. First, it is noted that for a given individual, the diploid genotype at any location in the alignment consists of two bases, two gaps, or a base pair and a gap, one for each chromosome. There are five possible options: ‘A’, ‘T’, ‘C’, ‘G’ and ‘*’. If haplotype phasing is ignored, there are a total of 15 possible genotypes at any given position. The probability of a successful read is calculated from the base quality score at a given position,

P=10^{-Q/10}

or from the average of the quality scores of the nearest basecalls in the case of a deletion at that position. The likelihood L of the observed base calls in each read from a given individual for each possible genotype at positions in the alignment is computed via the following set of cases:
(1) Homozygous genotype matched by the read: L=P
(2) Heterozygous genotype with one allele matched by the read: L=⅛+⅜P
(3) Homozygous genotype not matched by the read: L=¼ (1−P)
(4) Heterozygous genotype with neither allele matched by the read: L=¼(1−P)
The likelihood of the consensus basecall for the individual at a given position for each possible genotype can then be computed as the product of the likelihoods for contributing reads at that position:

L=Lr¹×Lr² . . . ×Lrⁱ

A number of additional strategies can be used to refine likelihood computation. These include, but are not limited to: using species, population, or kindred-based genotype priors, and setting non-uniform likelihoods for the various mismatch cases, and using a more sophisticated model to determining the likelihood of deletions from surrounding base calls.
Step 5 (110 in FIG. 1): The most likely shared genotype between individuals for each position is determined based on calculated per-individual base likelihoods at that position and the likelihood of shared haplotypes derived from a pedigree or other relationship data. A consensus base call and associated measure of confidence is made to determine the most likely shared genotype and define a multi-individual consensus for each position. This is done as follows. First, the total likelihood for combinations of individual genotypes at each position is computed. For example, for a family of three individuals, mother, father, and child, at each position in the reference sequence there at (15)³ possible cases. For each case, the relative likelihood λ of that specific combination of genotypes can be computed by multiplying the contributing per-individual genotype likelihoods together with a factor M representing the relative likelihood for the occurrence of the type of inheritance or mutational event that is represented by that case:

λ=L₁×L₂ . . . ×Lᵢ×M

A case in which both parents are (A/T) heterozygotes and their child (A/A) homozygote at a given position is consistent with common Mendelian inheritance is used to illustrate this step. A case with (A/T) heterozygous and (T/T) homozygous parents and a (G/T) heterozygous child is much less likely, as it would involve an intergenerational base substitution. These are relatively rare events; the human intergeneration mutation rate is estimated as approximately 1.1×10⁻⁸ per position per haploid genome. A case of an (A/A) homozygous parent, (T/T) homozygous parent, and (A/A) homozygous child would involve either a base substitution or an incidence of uniparental disomy, in which both copies of a chromosome are inherited from the same parent. Once the total likelihood of the set of reads given the (15)³ possible genotype combinations has been computed, the relative likelihood of each possible combination of individual genotypes is inferred via Bayes' Theorem:

P(X|Y)=[P(Y|X)×P(X)]/P(Y)

where X represents one of the possible (15)³ genotypes, and Y represents the set of reads (i.e., basecalls) at that position. Given that possible results are mutually exclusive and exhaustive, applying the a priori assumption that genotypes are equally likely simplifies the computation to:

P(X|Y)=P(Y|X)/T

where T is the sum of P(Y|X) over possible cases of X. Thus, the likelihood of each possible genotype combination in the group is computed for every point in the padded alignment.
Step 6 (112 in FIG. 1): All individual genotypes and confidence levels are then imputed based on the genotype combinations represented in the multi-individual consensus, to infer a final consensus sequence and confidence level at each position and to produce an error-corrected genome sequence for each individual. This process involves computing the probability P(X) for each of the 15 possible individual genotypes contributing to the set of (15)³ possible genotype combinations at each position. The most likely individual genotype is assigned and the total probability of that genotype is recorded as its confidence level.

### Example 2

### Inference of Degree of Relationship Between Biological Samples

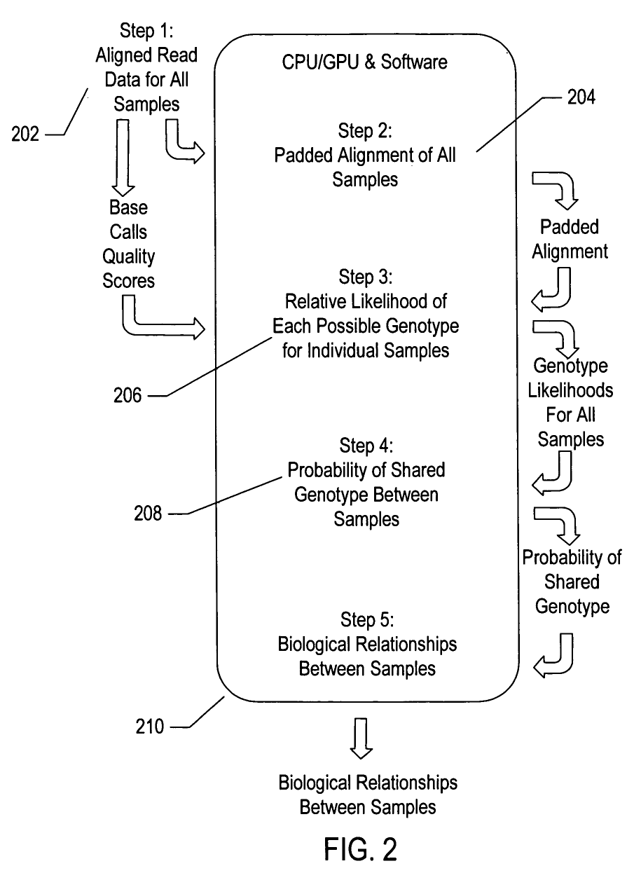

An example of the method of inferring the degree of biological relationship for a group of samples is presented in FIG. 2. In this example, samples are genomic DNA samples from multiple individuals where the degree of relationship is unknown.
Step 1 (202 in FIG. 1): As one input, the method receives nucleic acid sequence data for multiple individual samples. FIG. 3 shows a simple outline of the process of obtaining sequence data for a biological sample. Individual samples may be sequenced separately, or multiple individual samples can be barcoded with unique oligonucleotide tags, combined, and sequenced as a pool. Different samples from a group of related individuals may be sequenced to different average levels of coverage in order to optimize overall coverage of the group depending on the imputation algorithm and the knowledge of the biological relationship between individuals.
Step 2 (204 in FIG. 1): The alignment of read sequences is determined relative to the reference sequence and to each other. A padded multiple alignment of the read sequences is obtained by inserting some number of spaces ≧0, in each sequence position to yield sequence strings of equal length. This results in an array of multiple sequence alignments in which every position in the reference sequence is represented in the final padded alignment. For each position, there exists a set of reads from each individual that overlaps that location. For each read mapped to that position, there is either a basecall and associated quality score or a deletion relative to the padded alignment. All matches, simple mismatches, insertions, and deletions from each read can be properly mapped. An example of padded alignment is shown in FIG. 5.
Step 3 (206 in FIG. 1): For each individual, the relative likelihoods of the observed base calls and quality scores obtained from the set of sequence reads sampling that individual's genome, for each position in the alignment are determined for possible individual genotypes at that position. The likelihood of the consensus basecall for the individual at a given position for each possible genotype can then be computed as the product of the likelihoods for contributing reads at that position.
Step 4 (208 in FIG. 1): The probability of a shared genotype between individual samples is determined, based on the individual genotype likelihoods computed in the preceding step. More specifically, for some set of hypothetical relationships, the likelihood of the genotype combinations seen in the total set of multi-individual read data is computed for each relationship. For example, in a group of three individuals, there are (15)³ possible genotype combinations at each position in the alignment. For each case, the relative likelihood λ of each specific combination of genotypes for different degrees of relationship can be computed by multiplying the contributing per-individual genotype likelihoods together with a factor H representing the likelihood of a shared genotype for that degree of relationship based on Mendelian inheritance and a factor M representing the likelihood of a possible mutational event represented by that case:

λ=L₁×L₂ . . . ×Lᵢ×H×M

This is similar to Step 5 of the first process, with a difference that, in the absence of relationship priors, likelihood calculations are iterated over each possible degree of relationship and that only the overall relative likelihood λ of each relationship is kept for each position.
Step 5 (210 in FIG. 1): The biological relationships between samples can be inferred based on the calculated probability of shared genotypes. To do this, the relative likelihood λ computed in the previous step is combined for each position into a global likelihood Λ for a set of n relationships between individuals:

Λₙ=λ₁×λ₂ . . . ×λₙ

Although the present application has been described in terms of particular embodiments, it is not intended that the present disclosure be limited to these embodiments. Modifications will be apparent to those skilled in the art. For example, any of many different nucleic-acid isolation and processing methods can be used to extract sequence DNA and/or other information-encoding polymers in various steps of method embodiments. Embodiments can be implemented in various different ways, by varying any of many different implementation parameters, including programming language, modular organization, data structures, control structures, operating-system platform, and by varying additional implementation parameters.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A system for analysis of multiple biologically-related samples comprising:
receiving nucleic-acid sequence data for multiple individual samples obtained by extracting nucleic-acid from each sample, sequencing the extracted nucleic-acid, and alignment the sequences produced by sequencing the extracted nucleic acid;
carrying out base calls and computing quality scores for each sequence position;
receiving an indication of the biological relationships between the individual samples;
aligning read sequences relative to a reference sequence and to each other;
determining, for each individual, the relative likelihoods of the observed base calls and quality scores obtained from the set of sequence reads sampling that individual's genome for each position in the alignment are determined for individual genotypes at that position;
determining the most likely shared genotype between individuals for each position based on calculated per-individual base likelihoods at that position and the likelihood of shared haplotypes;
imputing individual genotypes and confidence levels based on the genotype combinations represented in a multi-individual consensus to infer a final consensus sequence and confidence level at each position and to produce an error-corrected genome sequence for each individual.


SEQUENCE LISTING (7 sequences)

SEQ ID NO: 1 - DNA, 23 bp, Artificial
  Hypothetical sequence used to illustrate padded alignment
cacgatcagaccgatacgtccga

SEQ ID NO: 2 - DNA, 16 bp, Artificial
  Hypothetical sequence used to illustrate padded alignment
cgatcagagaccgata

SEQ ID NO: 3 - DNA, 14 bp, Artificial
  Hypothetical sequence used to illustrate padded alignment
atcaagaccgatac

SEQ ID NO: 4 - DNA, 10 bp, Artificial
  Hypothetical sequence used to illustrate padded alignment
gatcagaccg

SEQ ID NO: 5 - DNA, 25 bp, Artificial
  Hypothetical sequence used to illustrate padded alignment
cacgatcanngaccgatacgtccga

SEQ ID NO: 6 - DNA, 15 bp, Artificial
  Hypothetical sequence used to illustrate padded alignment
atcanagaccgatac

SEQ ID NO: 7 - DNA, 12 bp, Artificial
  Hypothetical sequence used to illustrate padded alignment
gatcanngaccg